(19) United States
(12) Patent Application Publication
(10) Pub. No.: US 2005/0055882 A1
(43) Pub. Date: Mar. 17, 2005

(54) Door window glass regulator assembly for a vehicle

(76) Inventor: Eui-Chan Cho, Gyeonggi-do (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/749,252

(22) Filed: Dec. 30, 2003

(30) Foreign Application Priority Data
Sep. 16, 2003 (KR) 10-2003-0064177

(51) Int. Cl. E05F 11/44

(52) U.S. Cl. 49/351

(57) ABSTRACT

A door window glass regulator assembly for a vehicle that enables a window to ascend and descend silently without generating unwanted noise, thereby providing comfort to the passengers and a feeling of elegance to the vehicle.

### CROSS-REFERENCE TO RELATED APPLICATIONS

This application claims priority of Korean Application No. 10-2003-0064177, filed on Sep. 16, 2003, the disclosure of which is incorporated fully herein by reference.

### FIELD OF THE INVENTION

The present invention relates to a door window glass regulator assembly for a vehicle and, more particularly, to a window glass regulator assembly that enables a window to ascend and descend silently without generating unwanted noise.

### BACKGROUND OF THE INVENTION

A door window glass regulator assembly may be designed to enable a window to ascend and descend according to a passenger's need. The operation of the assembly may be silent, reducing discomfort to the passengers and providing a feeling of elegance to the vehicle.

### SUMMARY OF THE INVENTION

Embodiments of the present invention relate to a door window glass regulator assembly for a vehicle that enables a window to silently ascend and descend and suppress unwanted noise, thus providing comfort to the passengers and a feeling of elegance to the vehicle.

In accordance with an exemplary embodiment of the present invention, a door window glass regulator assembly for a vehicle may comprise a lifting arm and a glass rail slidably connected to the lifting arm, whereby vertical movement of the glass rail may be effected by rotary motion of the lifting arm. An auxiliary arm may also be hinged to the lifting arm and slidably connected to the glass rail. A support rail may slidably support the auxiliary arm. Two sliders may slidably connect the lifting arm and the auxiliary arm to the glass rail. A stop bar may be slidably inserted into the glass rail and the two sliders, and connecting means may connect the stop bar to one of the two sliders.

### BRIEF DESCRIPTION OF THE DRAWINGS

For a better understanding of the nature and objects of the present invention, reference should be made to the following detailed description with the accompanying drawings, in which:

FIG. 1 is a schematic drawing for illustrating a door window glass regulator assembly for a vehicle according to an embodiment of the present invention;

FIG. 2 is an exploded view of a slider and a stop bar of FIG. 1;

FIG. 3 is an assembled view of a slider connected to a stop bar of FIG. 2; and

FIG. 4 is a schematic drawing for illustrating an operation of a door window glass regulator assembly for a vehicle according to an embodiment of the present invention.

### DETAILED DESCRIPTION OF THE PREFERRED EMBODIMENT

The preferred embodiment of the present invention will now be described in detail with reference to the annexed drawings.

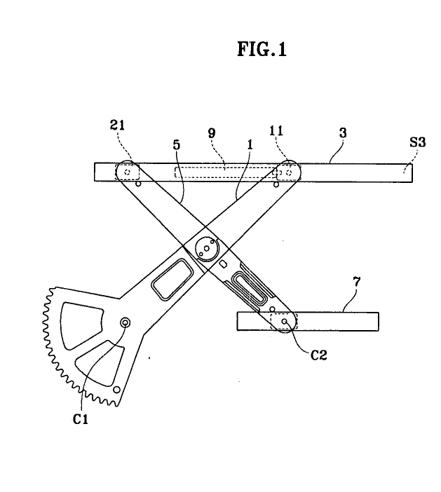

As shown in FIG. 1, the door window glass regulator assembly for a vehicle includes a lifting arm 1 rotated by a regulator motor (not shown), a glass rail 3 slidably connected to the lifting arm 1 for vertical movement by rotating motion of the lifting arm 1, an auxiliary arm 5 hinged to the lifting arm 1 and slidably connected to the glass rail 3, a support rail 7 for slidably supporting the auxiliary arm 5, two sliders for slidably connecting the lifting arm 1 and the auxiliary arm 5 to the glass rail 3, and a stop bar 9 slidably inserted into a gap formed between the glass rail 3 and the two sliders.

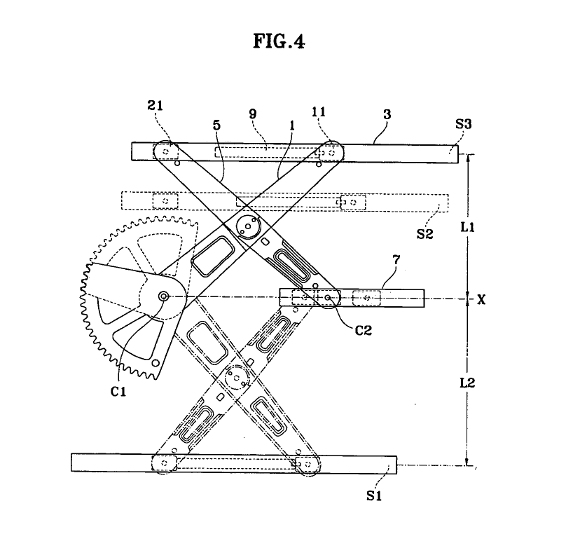

As illustrated in FIG. 4, L2 which downwardly covers a maximum distance from a straight line (X) to the glass rail 3 is longer than L1 which upwardly covers a maximum distance from the straight line (X) to the glass rail 3, where the straight line (X) is a line connecting a rotating axle (C1) of the lifting arm 1 to a rotating axle (C2) formed between the auxiliary arm 5 and the support rail 7.

One of the two sliders (in the present invention, the slider between the lifting arm 1 and the glass rail 3 is referred to as a connecting slider, while the remaining slider is referred to as an independent slider) is connected to the stop bar 9 via connecting means.

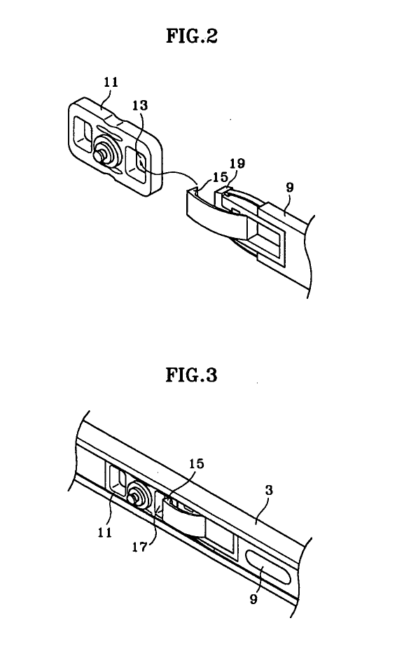

Referring to FIGS. 2 and 3, one exemplary connecting means of the present invention includes a hitching hole 13 formed at the connecting slider 11 and a hitching lug 15 formed at the stop bar 9 so as to be inserted into the hitching hole 13 and to allow the connecting slider 11 and the stop bar 9 to be integrated.

The stop bar 9 and the connecting slider 11 may be integrated while the hitching lug 15 is hitched at the hitching hole 13 such that the stop bar 9 and the connecting slider 11 integrally and linearly slide from the glass rail 3 when the window ascends.

The hitching lug 15 may be integrally formed as in the embodiment of the present invention, but may connect a hole separately formed at the stop bar 9 and the hitching hole 13 of the connecting slider 11 by being manufactured in a separate part. The stop bar 9 may be mounted at a distal end thereof with a damper pad 19 which functions as a buffer when the stop bar 9 and the slider come into contact therebetween.

Next, the operation of the door window glass regulator assembly for a vehicle thus constructed will be described, where S denotes a step.

When the window is completely opened, in other words, when the glass rail 3 is fully lowered, the independent slider 21 and the damper pad 19 of the stop bar 9 come into contact therebetween (S1).

In other words, the operation of the window being fully opened is realized by the oppositely linear-sliding independent slider 21 and the connecting slider 11 respectively being abutted to both sides of the stop bar 9.

Even though noise may be generated by the contact between the damper pad 19 of the stop bar 9 and the independent slider 21, this is insignificant because the noise is subtle, generated by the window being lowered.

When the window is raised under the above condition, the independent slider 21 and the connecting slider 11 slide away from one another (i.e., toward mutually distancing directions) to lift the glass rail 3. When the glass rail 3 passes the straight line (X) which connects the rotating axle (C1) of the lifting arm 1 to the rotating axle (C2) formed by the auxiliary arm 5 and the support rail 7, a gap formed by the independent slider 21 and the connecting slider 11 is narrowed to raise the glass rail 3 (refer to S2 of FIG. 4).

The connecting slider 11 and the stop bar 9 cannot be structurally touched therebetween because the stop bar 9 integrally moves with the connecting slider 11 such that there is no generation of unwanted noise from the connecting slider 11 and the stop bar 9.

Furthermore, the independent slider 21 and the damper pad 19 at the stop bar 9 do not meet each other until the window is completely raised (refer to S3 of FIG. 4). This is because the state of the window being fully raised to reach a zone of no-further-vertical-movement is realized, not by the contact between the stop bar 9 and the independent slider 21, but by a mechanism where the window itself touches an uppermost portion of the door to reach the zone of no-further-vertical-movement before the stop bar 9 and the independent slider 21 are mutually in contact therebetween.

In other words, it is because line L2 downwardly covering the maximum distance from the straight line (X) to the glass rail 3 is longer than line L1 upwardly covering the maximum distance from the straight line (X) to the glass rail 3, where the straight line (X) is a line connecting a rotating axle (C1) of the lifting arm 1 to a rotating axle (C2) formed by the auxiliary arm 5 and the support rail 7.

As a result, a door equipped with a door window glass regulator assembly for a vehicle thus constructed can maintain a silent operating state because unwanted noise is not generated by the stop bar 9 hitting the sliders.

For the foregoing reasons, the door window glass regulator assembly for a vehicle according to an exemplary embodiment of the present invention may provide a window which can ascend and descend silently by suppressing the generation of unwanted noise, thus providing comfort to the passengers and a feeling of elegance to the vehicle.

1. A door window glass regulator assembly for a vehicle comprising:
a lifting arm;
a glass rail slidably connected to the lifting arm for effecting vertical movement of the glass rail by rotational motion of the lifting arm;
an auxiliary arm hinged to the lifting arm and slidably connected to the glass rail;
a support rail for slidably supporting the auxiliary arm;
first and second sliders, the first slider slidably connecting the lifting arm to the glass rail, and the second slider slidably connecting the auxiliary arm to the glass rail;
a slidable stop bar between the two sliders; and
at least one connecting element for connecting said stop bar to one of the sliders.

2. The assembly of claim 1, wherein the lifting arm comprises a rotation point, and the lifting arm is rotatable about the rotation point.

3. The assembly of claim 2, wherein the auxiliary arm connects to the support rail through a hinge point.

4. The assembly of claim 3, wherein a maximum first distance measured downwardly from a straight line to the glass rail is greater than a maximum second distance measured upwardly from the straight line to the glass rail, the straight line being defined by the rotation point and the hinge point.

5. The assembly as defined in claim 1, wherein the at least one connecting element comprises:
a hitching hole in one slider; and
a hitching lug formed at the stop bar so as to be inserted into the hitching hole and to allow the slider and the stop bar to be integrated.

6. The assembly of claim 5, wherein the stop bar further comprises a damper to buffer contact between the stop bar and the one slider.
